(19) United States
(12) Patent Application Publication
(10) Pub. No.: US 2023/0325738 A1
(43) Pub. Date: Oct. 12, 2023

(54) MEETING RECURRENCE PLACEMENT OPERATOR

(71) Applicant: Microsoft Technology Licensing, LLC, Redmond, WA (US)

(72) Inventors: Warren David Johnson III, Sammamish, WA (US); Charles Yin-Che LEE, Mercer Island, WA (US); Xi DENG, Vancouver (CA)

(21) Appl. No.: 18/026,808

(22) PCT Filed: Aug. 31, 2021
(86) PCT No.: PCT/US2021/071319

§ 371 Date: Mar. 16, 2023

(30) Foreign Application Priority Data
Oct. 27, 2020 (LU) LU102158

(51) Int. Cl. G06Q 10/0631; G06Q 10/1093

(52) U.S. Cl. CPC G06Q 10/06314; G06Q 10/1095

(57) ABSTRACT

A system and method for allocating a recurring resource is described. The system receives a request to allocate the recurring resource of an application to computing devices associated with one or more users. The system identifies a cadence of the recurring resource and a range based on the cadence. A period is determines based on the cadence and the range. The system accesses user resource data of the application for each period and iteratively computes a resource availability score for the period based on the corresponding user resource data. The system determines that the resource availability score of an instance of the period is less than a threshold value and allocates the recurring resource to instances of the period where the corresponding resource availability score exceeds the threshold value.

### CLAIM FOR PRIORITY

This application claims the benefit of priority of Luxembourg Application Serial No. LU102158, filed Oct. 27, 2020, which is hereby incorporated by reference in its entirety.

### TECHNICAL FIELD

The subject matter disclosed herein generally relates to a special-purpose machine that allocates computing device resources associated with users, including computerized variants of such special-purpose machines and improvements to such variants. Specifically, the present disclosure addresses systems and methods for computing a resource availability score.

### BACKGROUND

Computing resources can be recurrently allocated by specifying a frequency and a number of instances of the allocation. For example, a user may specify a large number of static instances of the computing resources (e.g., processing power) based on an arbitrary number of recurrences. With larger number of recurrences, a larger number of computing resources are reserved and thus not available for other computation requests. Therefore, instances where the computing resources are not used contribute to inefficient operation of computing devices.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some example embodiments.

FIG. 2 is a block diagram illustrating a resource allocation engine in accordance with one example embodiment.

FIG. 3 is a block diagram illustrating a resource availability computation module in accordance with one example embodiment.

FIG. 4 is a flow diagram illustrating a method for scheduling instances of a recurring meeting in accordance with one example embodiment.

FIG. 5 is a flow diagram illustrating a method for computing a confidence score of a period in accordance with one example embodiment.

FIG. 6 is a flow diagram illustrating a method for iteratively computing available resources at each period in accordance with one example embodiment.

FIG. 7 illustrates a routine for allocating a recurring resource in accordance with one embodiment.

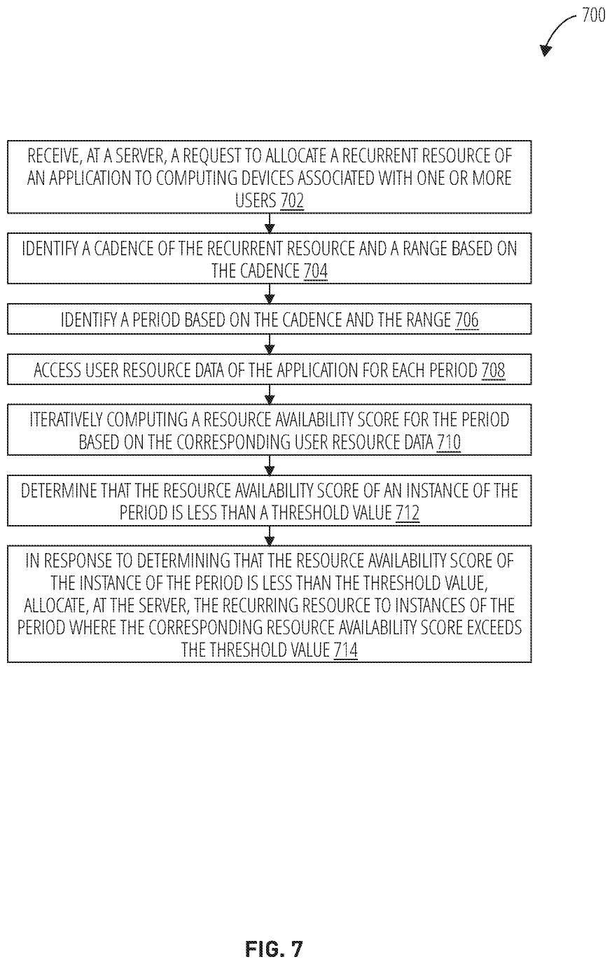

FIG. 8 illustrates an example of a range of a cadence and a period in accordance with one example embodiment.

FIG. 9 illustrates an example of schedule instances of a recurring meeting for a series of periods in accordance with one example embodiment.

FIG. 10 is a diagrammatic representation of a machine in the form of a computer system within which a set of instructions may be executed for causing the machine to perform any one or more of the methodologies discussed herein, according to an example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The present application describes a system for allocating a series of recurring resources at a computing device for users of an application. One example of recurring resources include processor power or memory storage of a computing device. For example, the application of a computing device includes a calendar application that manages resources of the computing devices for the users. The application can be configured to perform certain computing operations at certain specific times, thereby enabling the computing device to reduce processor cycles and power consumption at idle times. Other examples of recurring limited resources include memory usage, node processor power of a computing structure, configurations of the calendar application, and physical resources (e.g., meeting rooms).

The system can receive a request to schedule a series of recurring meetings. A conventional method for allocating the resources include reserving a large number of “static” instances based on (1) a number of instances arbitrarily chosen by the meeting organizer or (2) terminating the series of recurring meetings at a specific calendar endpoint. Allocating an unnecessary number of meeting instances to the calendar configurations of the application can result in potential waste. For example, a meeting room that was initially reserved at a particular date and time is not being used because the meeting is no longer needed. In other examples, the allocation of unnecessary instances of a recurring resource results in opportunity costs for the application/computing structures: a node could have been allocated to other tasks instead of hogging several instances of a task. Similarly, the allocation of unnecessary instances of meetings also results in opportunity costs for the users of the application: the users could have scheduled other activities in the calendar application.

In one example embodiment, the system allocates only the “next” item in a series of recurring resources to avoid tying up limited resources (e.g., physical conference room, node processing power, calendar slots). The present application describes a method for sensing and determining how many future instances in the series (e.g., from 1 to n) are to be allocated now based on factors such as a resource availability for an instance of a range of a cadence and a confidence score computed based on the resource availability and a threshold value. The cadence may refer to a frequency of the repeating event. For example, a cadence may be weekly if the event is to be repeated on a weekly basis. The range of the cadence refer to a preset window of time based on the frequency of the cadence. For example, the range of a weekly cadence may be two 24-hour period.

For example, the system periodically calculates the number of available slots that would satisfy a required cadence (e.g., weekly meeting). If the number of available slots falls below a pre-determined threshold, the system allocates/schedules an instance of the meeting. For example, the system starts from a latest instance that is scheduled in the future. The system scans in periodic ranges beyond that date for available slots within each iteration that would satisfy the attendee availability and resource requirements. However, if at any iteration, the number of available slots within a range that satisfies the request falls below a minimum value, the system not only schedule for that week but also all preceding weeks up to the previously scheduled instance.

In one example embodiment, the present application describes a system and method for allocating a recurring resource. The system receives a request to allocate the recurring resource of an application to computing devices associated with one or more users. The system identifies a cadence of the recurring resource and a range based on the cadence. A period is determined based on the cadence and the range. The system accesses user resource data of the application for each period and iteratively computes a resource availability score for the period based on the corresponding user resource data. The system determines that the resource availability score of an instance of the period is less than a threshold value and allocates the recurring resource to instances of the period where the corresponding resource availability score exceeds the threshold value.

In another example embodiment, a period is determined (e.g. Monday 2 pm to 4 pm) based on the cadence (e.g., weekly) and the range (e.g., 10 occurrences). The system accesses user resource data of the application for each period (calendar data for Mondays 2 pm to 4 pm for the next 10 weeks). The system computes a resource availability score for each of the 10 Mondays. If the score is less than a threshold for any of the 10 Mondays then the recurring meeting is booked for all of the 10 Mondays.

As a result, one or more of the methodologies described herein facilitate solving the technical problem of efficient resource allocation by identifying available recurring resources and iteratively securing those available resources. The presently described tool provides an improvement to an operation of the functioning of a computer by providing incremental resource allocation and application configurations, increased scheduling flexibility, and smaller memory requirements. As such, one or more of the methodologies described herein may obviate a need for certain efforts or computing resources. Examples of such computing resources include processor cycles, network traffic, memory usage, data storage capacity, power consumption, network bandwidth, and cooling capacity. Resource allocation is achieved in a dynamic manner in cases where a resource is to be recurrently allocated. As a result of the dynamic allocation more efficient use of the resources is achieved. The resource is shared in the sense that the allocation of the resource is made to more than one entity (such as more than one computing device which will participate in an online meeting). Since the entities have availabilities which change over time there is significant complexity in finding suitable resource allocations. The technology of the disclosure facilitates allocation in a manner which makes very efficient use of the resources and which is able to cope with the complexity in a simple manner through use of the resource availability score.

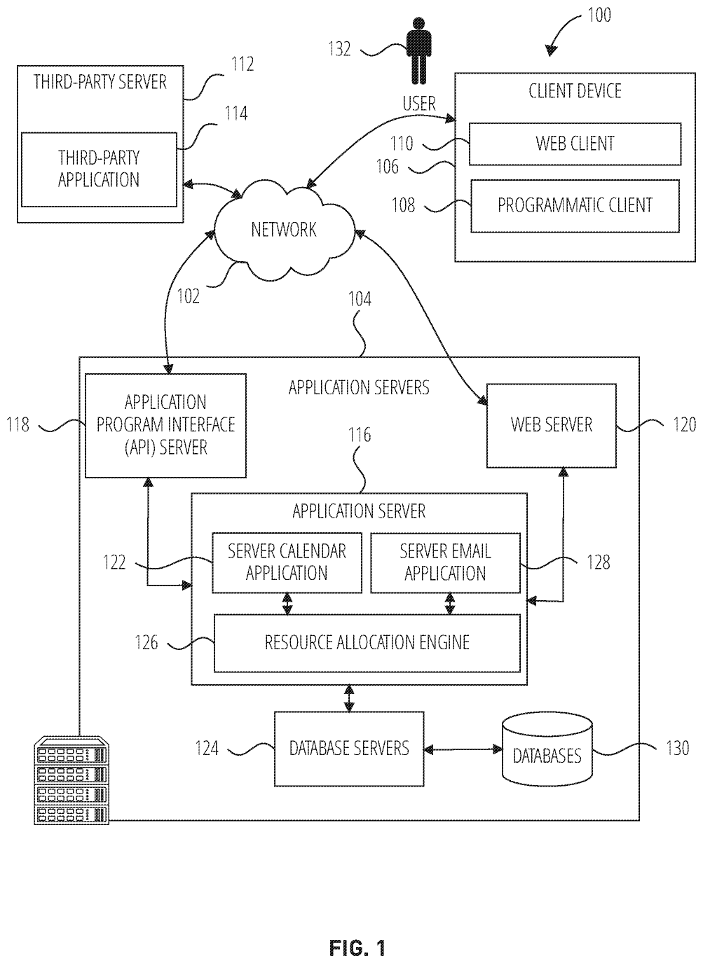

FIG. 1 is a diagrammatic representation of a network environment 100 in which some example embodiments of the present disclosure may be implemented or deployed. One or more application servers 104 provide server-side functionality via a network 102 to a networked user device, in the form of a client device 106. A user 132 operates the client device 106. The client device 106 includes a web client 110 (e.g., a browser), a programmatic client 108 (e.g., an email/calendar application such as Microsoft Outlook™) that is hosted and executed on the client device 106. In one example embodiment, the user 132 operates the programmatic client 108 to submit a request to allocate a recurring resource of the programmatic client 108 (e.g., request to reserve a weekly meeting with other users).

An Application Program Interface (API) server 118 and a web server 120 provide respective programmatic and web interfaces to application servers 104. A specific application server 116 hosts a server calendar application 122, a server email application 128, and a resource allocation engine 126. The server calendar application 122, the server email application 128, and the resource allocation engine 126 include components, modules and/or applications.

The server calendar application 122 stores and updates calendar data associated with a user account of the user 132 and other users of the server calendar application 122. The web client 110 and the programmatic client 108 communicate with the server calendar application 122. The server email application 128 stores and updates email data associated with the user account of the user 132 and other users of the server calendar application 122. The web client 110 and the programmatic client 108 communicate with the server email application 128.

Both the server calendar application 122 and the server email application 128 communicate with the resource allocation engine 126. In one example embodiment, the resource allocation engine 126 detects a request to allocate a recurring resource from the server calendar application 122 or the server email application 128. For example, the resource allocation engine 126 detects a meeting request from the user 132 via the web client 110 or the programmatic client 108, and the server calendar application 122 or the server email application 128.

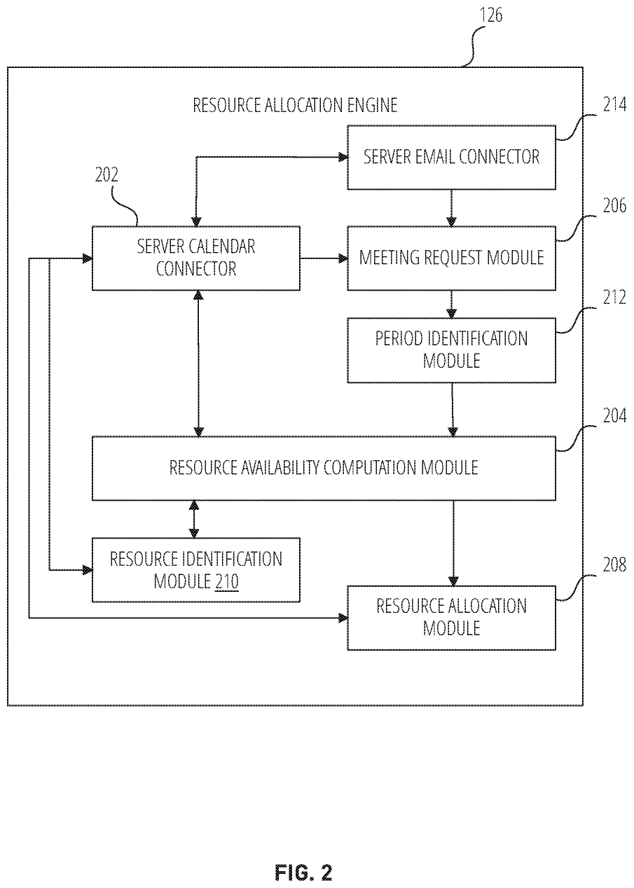

The resource allocation engine 126 identifies a cadence of the meeting request (e.g., weekly, monthly) and determines a range based on the cadence (e.g., +/−1 day for weekly meetings, 5-day range for a monthly meeting). The resource allocation engine 126 starts from a latest instance that is scheduled in the future and scans in periodic ranges beyond that date for available slots within each iteration that would satisfy the attendee availability and resource requirements. For example, the resource allocation engine 126 determines that user 132 has 5 available slots (e.g., 1-hour slot) for a weekly one-hour meeting request, during a first period (e.g., first week of November), 4 available slots during a second period following the first period (e.g., second week of November), and 2 available slots during a third period following the second period (e.g., third week of November). The resource allocation engine 126 determines that the resource availability of the first period is greater than an available threshold value (e.g., threshold is 3 slots) and iteratively continues computing for the next period until the resource availability of the next period is less than the available threshold value. The resource allocation engine 126 then allocates resources for all instances up to the period where the resource availability is less than the available threshold value. In another example, if at any iteration, the number of available slots within a range that satisfies the request falls below the available threshold value, the system not only schedules for that week but also for all preceding weeks up to the previously scheduled instance. The resource allocation engine 126 is described in more detail below with respect to FIG. 2.

The resource allocation engine 126 allocates the resources by reserving the identified instances of the meetings with the server calendar application 122. The server email application 128 communicates with the client device 106 (and other client devices of other users) to identify the reserved instances. In one example, the web client 110 communicate with the resource allocation engine 126, server calendar application 122, and server email application 128 via the programmatic interface provided by the Application Program Interface (API) server 118.

The third-party application 114 may, for example, be another cloud storage system. The application server 116 is shown to be communicatively coupled to database servers 124 that facilitates access to an information storage repository or databases 130. In an example embodiment, the databases 130 includes storage devices that store information to be published and/or processed by at least one of the server calendar application 122, the server email application 128, and the resource allocation engine 126.

Additionally, a third-party application 114 executing on a third-party server 112, is shown as having programmatic access to the application server 116 via the programmatic interface provided by the Application Program Interface (API) server 118. For example, the third-party application 114, using information retrieved from the application server 116, may supports one or more features or functions on a website hosted by the third party.

FIG. 2 is a block diagram illustrating the resource allocation engine 126 in accordance with one example embodiment. The resource allocation engine 126 comprises a server calendar connector 202, a resource availability computation module 204, a meeting request module 206, a resource allocation module 208, a resource identification module 210, a period identification module 212, and a server email connector 214.

The server calendar connector 202 interfaces with the server calendar application 122 to access calendar data of the users of the server calendar application 122. The calendar data indicates, for example, available times, reserved times of the corresponding user. The calendar data may also indicate a start time, an end time, a geographical location (e.g., meeting room), a meeting link to a communication application (e.g., Teams from Microsoft), and identify other users invited to the meeting or those who have indicated as planning to attend the meeting. In another other example, the server calendar connector 202 detects that a user has submitted a request for a meeting to other users.

The server email connector 214 interfaces with the server email application 128 to access email data of the users of the server email application 128. The email data may include an email indicating a request for a recurring meeting with other others. For example, the email data includes a request for a weekly meeting starting on the first week of November.

The meeting request module 206 detects from the server calendar connector 202 and the server email connector 214 that a user has requested for a recurring meeting (via the server calendar application 122 or the server email application 128). The meeting request module 206 may identify a starting date for the meeting and a cadence of the recurring meeting. For example, the cadence may be weekly, monthly, annually, and so forth.

The period identification module 212 identifies a range based on cadence of the meeting request. In one example embodiment, the period identification module 212 accesses a table that maps the cadence to a time range. For example, a weekly cadence may be mapped to a two-day range (e.g., Wednesday and Thursday or any two days out of the work week). In another example, a monthly cadence may be mapped to a 5 day range (e.g., a Monday to Friday, any week of the month). In one example embodiment, the user 132 can customize the mapped range in the table. In another example embodiment, the mapped table is predefined and preset by an administrator of the server calendar application 122.

The period identification module 212 identifies periods from the ranges and the cadence of the meeting request. The period comprises specific dates. For example, for a weekly meeting request starting the first week of November, the first period of the weekly meeting request may be Wednesday and Thursday of the first week of November. The second period (following the first period) may be Wednesday and Thursday of the second week of November. The third period (following the second period) may be Wednesday and Thursday of the third week of November. As such, the period indicates a specific window of time based on the cadence and the range.

The resource availability computation module 204 communicates with the server calendar connector 202 and the resource identification module 210 to identify available resources (e.g., available time or unscheduled time, available meeting rooms, available hardware resources) for a user of the server calendar application 122. The resource identification module 210 identifies available time slots from calendar data of the user of the server calendar application 122. In one example embodiment, the resource identification module 210 identifies available time slots based on the duration of the meeting request. For example, for a meeting request that indicates a weekly one-hour meeting, the resource identification module 210 identifies one-hour available time slots (within preset working hours) in the calendar data of the users. In another example, for a meeting request that indicates a monthly two-hour meeting, the resource identification module 210 identifies two-hour available time slots (within preset working hours) in the calendar data of the users.

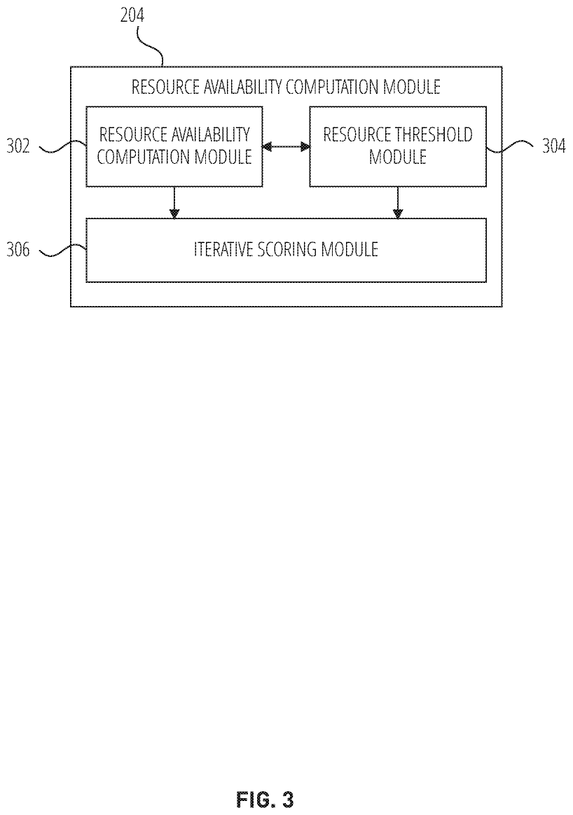

The resource availability computation module 204 retrieves the identified available resources as determined by the resource identification module 210 and iteratively computes a confidence score for each period based on the available resources from the period and an availability threshold value. If the resource availability computation module 204 determines that the confidence score for a first period exceeds the availability threshold value, the resource availability computation module 204 iteratively computes the confidence score for the next period (e.g., the second period). If the resource availability computation module 204 determines that the confidence score for the next period is lower than the availability threshold value, the resource availability computation module 204 identifies all periods preceding the period that fails to meet the availability threshold value. An example embodiment of the resource availability computation module 204 is described in more detail below with respect to FIG. 3.

The resource allocation module 208 retrieves the periods identified from the resource availability computation module 204 and allocates resources to those identified periods (e.g., first period and second period). For example, the resource allocation module 208 reserves a weekly meeting on Wednesday in the first period and on Thursday in the second period. In another example, the resource allocation module 208 allocates processing power to nodes at the times identified in the identified periods.

FIG. 3 is a block diagram illustrating the resource availability computation module 204 in accordance with one example embodiment. The resource availability computation module 204 comprises a resource availability computation module 302, a resource threshold module 304, and an iterative scoring module 306.

The resource availability computation module 302 determines the number of available slots within the range of each period. For example, the resource availability computation module 302 determines that a meeting request that indicates a weekly one-hour meeting. The resource availability computation module 302 identifies one-hour available time slots (within the range of the period) in the calendar data of the users. For example, the resource availability computation module 302 accesses the calendar data for Wednesday and Thursday (for a particular week) for a user and determines the number of one-hour available time slots on Wednesday and Thursday (within predefined working hours). For example, the resource availability computation module 302 determines that the user 132 has 6 available one-hour slots on Wednesday and Thursday of the first period for the first week of November, 7 available one-hour slots on Wednesday and Thursday of the second period for the second week of November, and 3 available one-hour slots on Wednesday and Thursday of the third period for the third week of November.

The resource threshold module 304 identifies an availability threshold value based on the cadence of the request. For example, a predefined table may map the cadence of a one-hour weekly request to a value of 5 one-hour slots. In another example, an administrator of the server calendar application 122 may set the availability threshold value of the resource threshold module 304. In another example, the resource threshold module 304 may adjust the availability threshold value based on the number of periods identified as available for scheduling. For example, if only one period is identified as available for scheduling (e.g., the number of available one-hour slots in that period is greater than the availability threshold value) for a number of users, the resource threshold module 304 may lower the availability threshold value to increase the number of periods identified as available for scheduling. Conversely, if many periods (e.g., more than 10) are identified as available for scheduling for a number of users, the resource threshold module 304 may increase the availability threshold value to decrease the number of periods identified as available for scheduling.

The iterative scoring module 306 computes, for a period, a confidence score based on the identified available resources (e.g., number of available slots within a range of a period) determined by the resource availability computation module 302 and the availability threshold value retrieved from the resource threshold module 304. The confidence score indicates that the recurring resources may not be available unless they are secured (e.g., scheduled) ahead of time. For example, the confidence score may be computed by subtracting the availability threshold value (e.g., 5) from the number of available resources within the range of the period (e.g., 8 one-hour slots) and dividing the result by the total number of (scheduled and unscheduled) slots in the period (e.g., 16 one-hour slots for Wednesday and Thursday). Thus, the confidence score for the above example is (8−5)/16=0.19. A higher confidence score may indicate a higher likelihood of the availability for the meeting request during that period. A lower confidence score may indicate a lower likelihood of the availability for the meeting request during that period.

If the confidence score of a period exceeds a confidence threshold value, the iterative scoring module 306 computes the confidence score for the next period. The iterative scoring module 306 iteratively computes the confidences score for a following period until the confidence score of the following period is lower than the confidence threshold value. Once detected, the iterative scoring module 306 directs the resource allocation module 208 to reserve all prior periods leading up to the period with the confidence score lower than the confidence threshold value.

In another example embodiment, the resource availability computation module 204 may direct the resource allocation module 208 to reserve each consecutive period based on the confidence score. For example, the resource allocation module 208 reserves a recurring resource at each period where the corresponding confidence score is less than the confidence threshold score (e.g., 0.1).

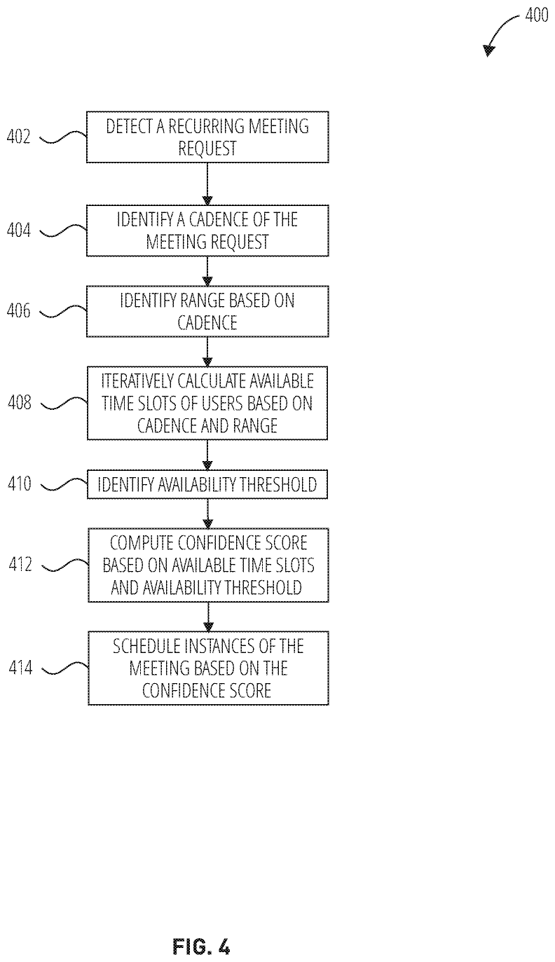

FIG. 4 is a flow diagram illustrating a method 400 for scheduling instances of a recurring meeting in accordance with one example embodiment. Operations in the method 400 may be performed by the resource allocation engine 126, using components (e.g., modules, engines) described above with respect to FIG. 2. Accordingly, the method 400 is described by way of example with reference to the resource allocation engine 126. However, it shall be appreciated that at least some of the operations of the method 400 may be deployed on various other hardware configurations or be performed by similar components residing elsewhere.

At block 402, the resource allocation engine 126 detects a recurring meeting request. For example, the resource allocation engine 126 detects that the user 132 has requested a weekly meeting with other identified users starting the first week of November.

At block 404, the resource allocation engine 126 identifies the cadence of the meeting request. For example, the resource allocation engine 126 determines that the cadence is weekly.

At block 406, the resource allocation engine 126 identifies a range based on the cadence. For example, the resource allocation engine 126 accesses a predefined table that maps ranges to cadences, such as two-day range for a weekly cadence.

At block 408, the resource allocation engine 126 iteratively calculates available time slots of the users based on the cadence and range of the meeting request. For example, the resource allocation engine 126 determines that the user 132 has 8 available one-hour time slots on Wednesday and Thursday of the first week of November. The resource allocation engine 126 calculates available time slots for the user 132 for the second week of November.

At block 410, the resource allocation engine 126 identifies the availability threshold value corresponding to the cadence, the range, or a type of meeting. For example, the availability threshold value may be 5 one-hour slots for a weekly review meeting.

At block 412, the resource allocation engine 126 computes the confidence score based on the available time slots and the availability threshold value. Based on the above example, the confidence score is (8−5)/16=0.19.

At block 414, the resource allocation engine 126 schedules instances of the meetings based on the confidence score exceeding a confidence threshold value. For example, the resource allocation engine 126 will schedule a one-hour meeting on Wednesday of the first period.

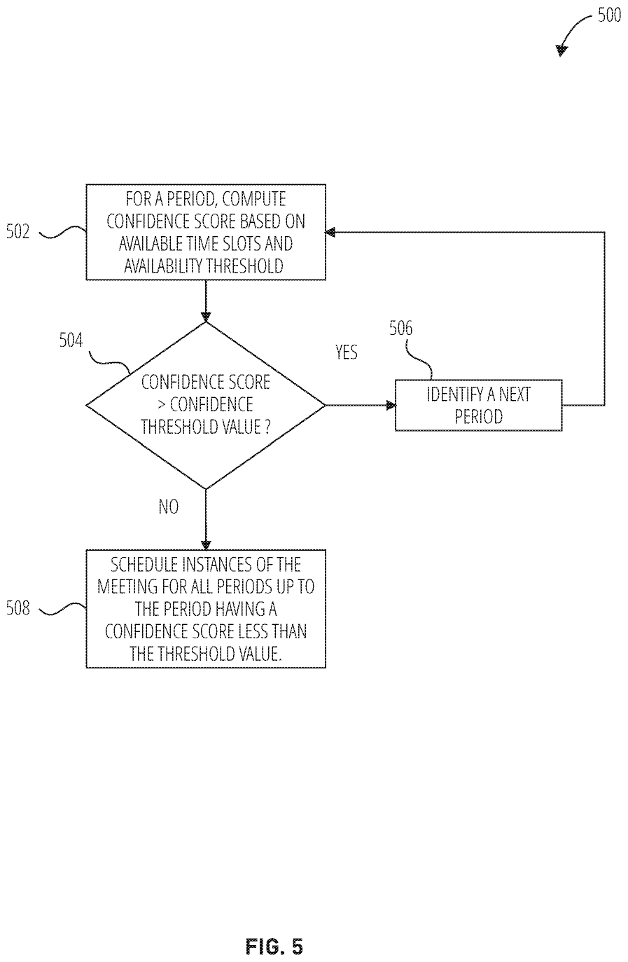

FIG. 5 is a flow diagram illustrating a method 500 for computing a confidence score of a period in accordance with one example embodiment. Operations in the method 500 may be performed by the resource allocation engine 126, using components (e.g., modules, engines) described above with respect to FIG. 2. Accordingly, the method 500 is described by way of example with reference to the resource allocation engine 126. However, it shall be appreciated that at least some of the operations of the method 500 may be deployed on various other hardware configurations or be performed by similar components residing elsewhere.

At block 502, the resource allocation engine 126 computes, for a period, a confidence score based on the number of available time slots and the availability threshold value. At decision block 504, the resource allocation engine 126 determines whether the confidence score exceeds the confidence threshold value. If the resource allocation engine 126 determines that the confidence score for the period exceeds the confidence threshold value, the resource allocation engine 126 identifies the next period at block 506. If the resource allocation engine 126 determines that the confidence score for the period is lower than the confidence threshold value, the resource allocation engine 126 directs the resource allocation module 208 to schedule instances of the meeting for all periods up to the period that has a lower confidence score at block 508.

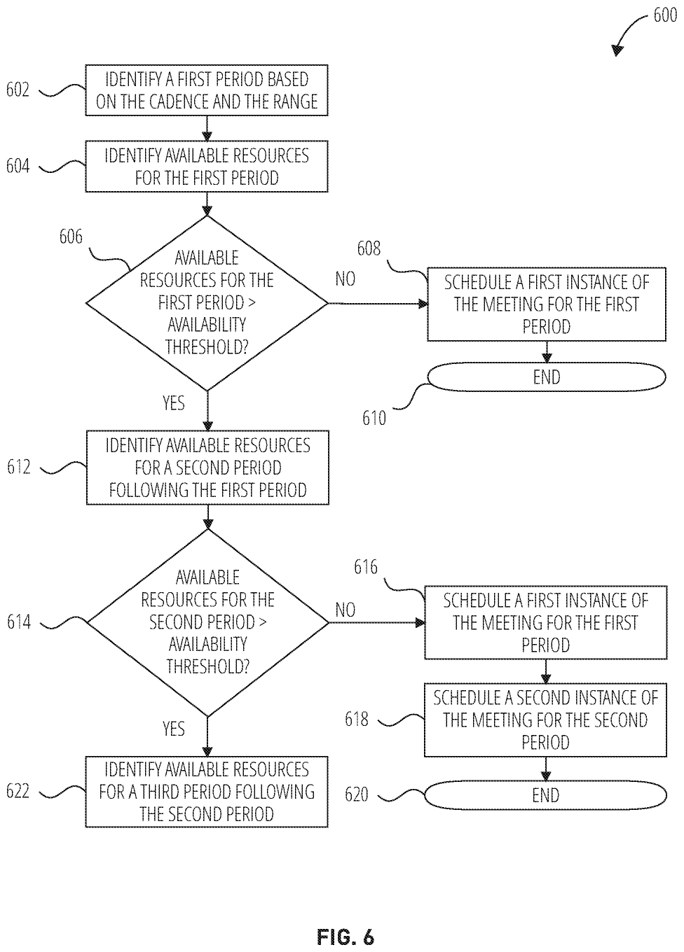

FIG. 6 is a flow diagram illustrating a method 600 for iteratively computing available resources at each period in accordance with one example embodiment. Operations in the method 600 may be performed by the resource allocation engine 126, using components (e.g., modules, engines) described above with respect to FIG. 2. Accordingly, the method 600 is described by way of example with reference to the resource allocation engine 126. However, it shall be appreciated that at least some of the operations of the method 600 may be deployed on various other hardware configurations or be performed by similar components residing elsewhere.

At block 602, the resource allocation engine 126 identifies a first period based on the cadence and the range. At block 604, the resource allocation engine 126 identifies available resources for the first period.

At decision block 606, the resource allocation engine 126 determines whether the available resources for the first period exceed the availability threshold value. If the resource allocation engine 126 determines that the available resources for the first period is lower than the availability threshold value, the resource allocation engine 126 schedules a first instance of the meeting for the first period at block 608 and ends the process at block 610.

At block 612, the resource allocation engine 126 identifies available resources for a second period following the first period. At decision block 614, the resource allocation engine 126 determines whether the available resources for the second period exceed the availability threshold value. If the resource allocation engine 126 determines that the available resources for the second period is lower than the availability threshold value, the resource allocation engine 126 schedules a first instance of the meeting for the first period at block 616, schedules a second instance of the meeting for the second period at block 618, and ends the process at block 620.

If the resource allocation engine 126 determines that the available resources for the second period exceeds the availability threshold value, the resource allocation engine 126 identifies available resources for a third period following the second period at block 622.

In block 702, routine 700 receives, at a server, a request to allocate a recurrent resource of an application to computing devices associated with one or more users. In block 704, routine 700 identifies a cadence of the recurrent resource and a range based on the cadence. In block 706, routine 700 identifies a period based on the cadence and the range. In block 708, routine 700 accesses user resource data of the application for each period. In block 710, routine 700 iteratively computes a resource availability score for the period based on the corresponding user resource data. In block 712, routine 700 determines that the resource availability score of an instance of the period is less than a threshold value. In block 714, routine 700 in response to determining that the resource availability score of the instance of the period is less than the threshold value, allocates, at the server, the recurring resource to instances of the period where the corresponding resource availability score exceeds the threshold value.

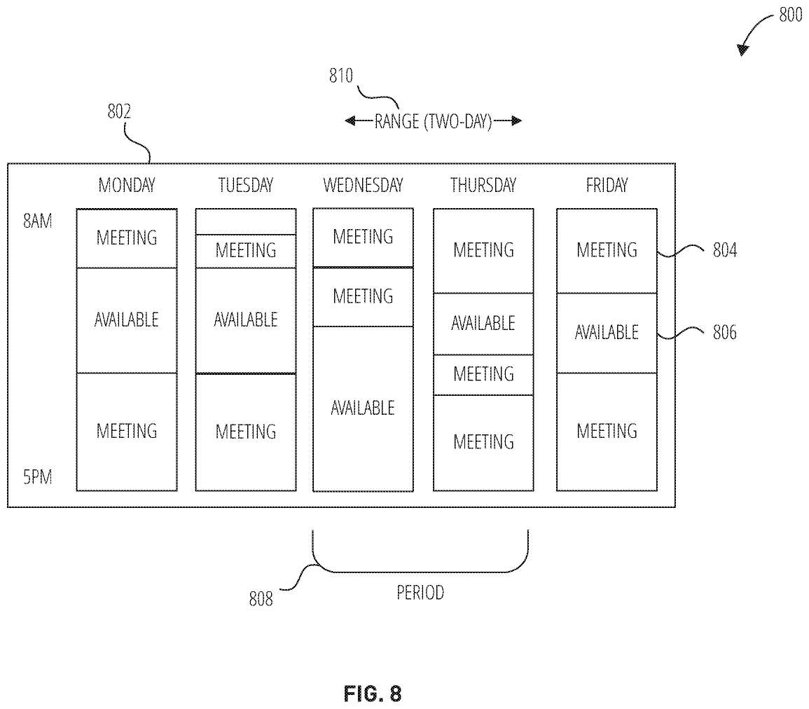

FIG. 8 illustrates an example of a graphical user interface 800 in accordance with one example embodiment. The graphical user interface 800 illustrates a chart of a weekly calendar 802 with meeting time slots 804, and available time slots 806. The range 810 is based on a weekly cadence. For example, the range 810 indicates a two-day range (Wednesday and Thursday). The range may include other days such as Monday and Friday, or Monday and Tuesday. The period 808 indicates the actual dates of the range (e.g., Wednesday November 4th, and Thursday November 5th).

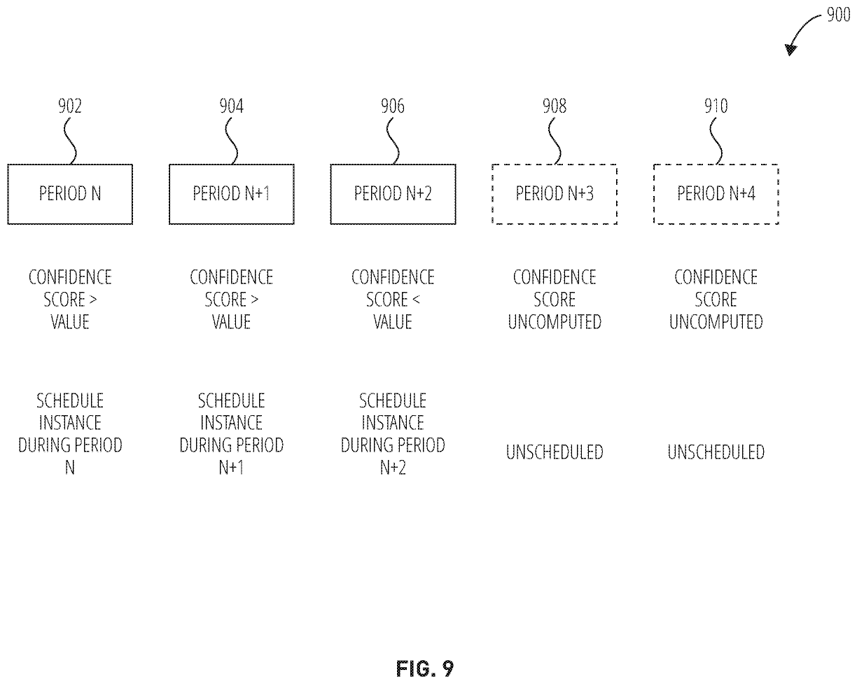

FIG. 9 illustrates an example of a graphical user interface 900 in accordance with one example embodiment. The graphical user interface 900 illustrates a period n 902, period n+1 904, period n+2 906, period n+3 908, and period n+4 910. For each period, the resource allocation engine 126 calculates its corresponding confidence score. The resource allocation engine 126 determines that the confidence scores for the period n 902 and period n+1 904 (up to period n+2 906) exceed the confidence threshold value. The resource allocation engine 126 schedules the instance of the meeting for period n 902, period n+1 904, and period n+2 906.

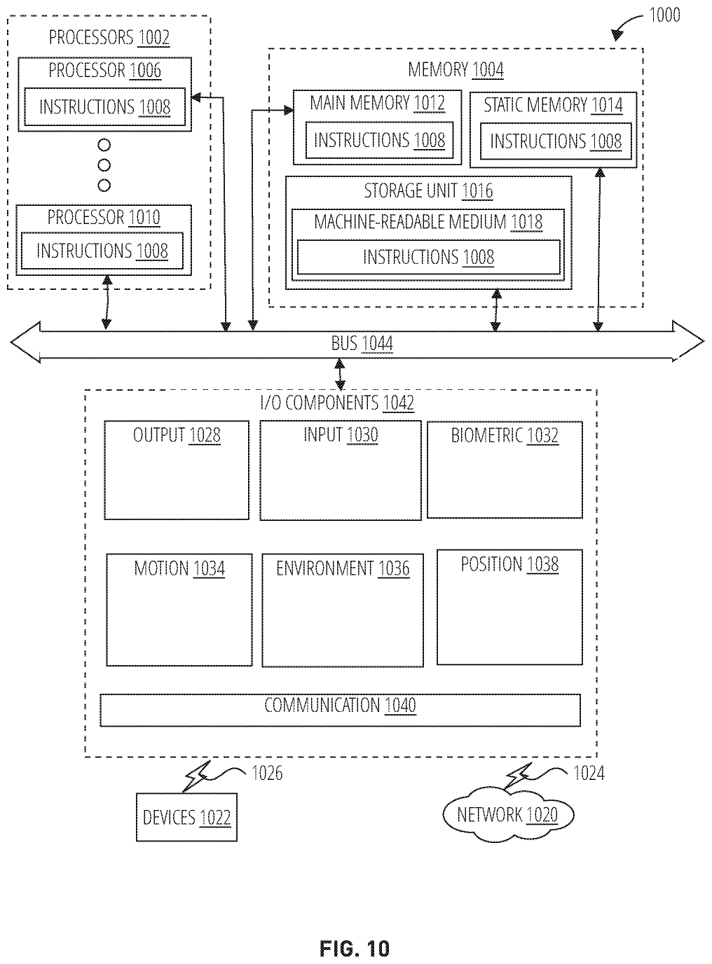

FIG. 10 is a diagrammatic representation of the machine 1000 within which instructions 1008 (e.g., software, a program, an application, an applet, an app, or other executable code) for causing the machine 1000 to perform any one or more of the methodologies discussed herein may be executed. For example, the instructions 1008 may cause the machine 1000 to execute any one or more of the methods described herein. The instructions 1008 transform the general, non-programmed machine 1000 into a particular machine 1000 programmed to carry out the described and illustrated functions in the manner described. The machine 1000 may operate as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1008, sequentially or otherwise, that specify actions to be taken by the machine 1000. Further, while only a single machine 1000 is illustrated, the term “machine” shall also be taken to include a collection of machines that individually or jointly execute the instructions 1008 to perform any one or more of the methodologies discussed herein.

The machine 1000 may include processors 1002, memory 1004, and I/O components 1042, which may be configured to communicate with each other via a bus 1044. In an example embodiment, the processors 1002 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1006 and a processor 1010 that execute the instructions 1008. The term “processor” is intended to include multi-core processors that may comprise two or more independent processors (sometimes referred to as “cores”) that may execute instructions contemporaneously. Although FIG. 10 shows multiple processors 1002, the machine 1000 may include a single processor with a single core, a single processor with multiple cores (e.g., a multi-core processor), multiple processors with a single core, multiple processors with multiples cores, or any combination thereof.

The memory 1004 includes a main memory 1012, a static memory 1014, and a storage unit 1016, both accessible to the processors 1002 via the bus 1044. The main memory 1004, the static memory 1014, and storage unit 1016 store the instructions 1008 embodying any one or more of the methodologies or functions described herein. The instructions 1008 may also reside, completely or partially, within the main memory 1012, within the static memory 1014, within machine-readable medium 1018 within the storage unit 1016, within at least one of the processors 1002 (e.g., within the processor's cache memory), or any suitable combination thereof, during execution thereof by the machine 1000.

The I/O components 1042 may include a wide variety of components to receive input, provide output, produce output, transmit information, exchange information, capture measurements, and so on. The specific I/O components 1042 that are included in a particular machine will depend on the type of machine. For example, portable machines such as mobile phones may include a touch input device or other such input mechanisms, while a headless server machine will likely not include such a touch input device. It will be appreciated that the I/O components 1042 may include many other components that are not shown in FIG. 10. In various example embodiments, the I/O components 1042 may include output components 1028 and input components 1030. The output components 1028 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1030 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1042 may include biometric components 1032, motion components 1034, environmental components 1036, or position components 1038, among a wide array of other components. For example, the biometric components 1032 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1034 include acceleration sensor components (e.g., accelerometer), gravitation sensor components, rotation sensor components (e.g., gyroscope), and so forth. The environmental components 1036 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1038 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1042 further include communication components 1040 operable to couple the machine 1000 to a network 1020 or devices 1022 via a coupling 1024 and a coupling 1026, respectively. For example, the communication components 1040 may include a network interface component or another suitable device to interface with the network 1020. In further examples, the communication components 1040 may include wired communication components, wireless communication components, cellular communication components, Near Field Communication (NFC) components, Bluetooth® components (e.g., Bluetooth® Low Energy), WiFi® components, and other communication components to provide communication via other modalities. The devices 1022 may be another machine or any of a wide variety of peripheral devices (e.g., a peripheral device coupled via a USB).

Moreover, the communication components 1040 may detect identifiers or include components operable to detect identifiers. For example, the communication components 1040 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1040, such as location via Internet Protocol (IP) geolocation, location via Wi-Fi® signal triangulation, location via detecting an NFC beacon signal that may indicate a particular location, and so forth.

The various memories (e.g., memory 1004, main memory 1012, static memory 1014, and/or memory of the processors 1002) and/or storage unit 1016 may store one or more sets of instructions and data structures (e.g., software) embodying or used by any one or more of the methodologies or functions described herein. These instructions (e.g., the instructions 1008), when executed by processors 1002, cause various operations to implement the disclosed embodiments.

The instructions 1008 may be transmitted or received over the network 1020, using a transmission medium, via a network interface device (e.g., a network interface component included in the communication components 1040) and using any one of a number of well-known transfer protocols (e.g., hypertext transfer protocol (HTTP)). Similarly, the instructions 1008 may be transmitted or received using a transmission medium via the coupling 1026 (e.g., a peer-to-peer coupling) to the devices 1022.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

### EXAMPLES

Example 1 is a computer-implemented method comprising: receiving, at a server, a request to allocate a recurring resource of an application to computing devices associated with one or more users; identifying a cadence of the recurring resource and a range based on the cadence; identifying a period based on the cadence and the range; accessing user resource data of the application for each period; iteratively computing a resource availability score for the period based on the corresponding user resource data; determining that the resource availability score of an instance of the period is less than a threshold value; and in response to determining that the resource availability score of the instance of the period is less than the threshold value, allocating, at the server, the recurring resource to instances of the period where the corresponding resource availability score exceeds the threshold value.

Example 2 includes example 1, comprising: determining, for each period, a number of available time slots, in calendar data of the one or more users, that are available to accommodate the request; and computing the resource availability score for each period based on the number of available time slots of the one or more users for each period.

Example 3 includes example 1 or example 2, comprising: computing a first resource availability score for a first instance of the period based on the corresponding user resource data; determining that the first resource availability score of the first instance of the period is greater than the threshold value; and in response to determining that the first resource availability score of first instance of the period is greater than the threshold value, iteratively computing a second resource availability score for a second instance of the period based on the corresponding user resource data.

Example 4 includes example 3, comprising: determining that the second resource availability score of the second instance of the period is less than the threshold value; and allocating, at the server, the recurring resource to the first instance of the period.

Example 5 includes of example 3 or example 4, comprising: determining that the second resource availability score of the second instance of the period is greater than the threshold value; in response to determining that the second resource availability score of second instance of the period is greater than the threshold value, iteratively computing a third resource availability score for a third instance of the period based on the corresponding user resource data; determining that the third resource availability score of the third instance of the period is less than the threshold value; and allocating, at the server, the recurring resource to the first and second instance of the period.

Example 6 includes any preceding examples, comprising: monitoring the resource availability score for each future period based on the corresponding user resource data; and adjusting the threshold value based on the resource availability score for each future period.

Example 7 includes any preceding examples, comprising: accessing a mapping table that maps the cadence with a time margin; and determining the range based on the time margin from the mapping table.

Example 8 includes any preceding examples, wherein the recurring resource identifies a recurring available time slot in calendar data of the user resource data.

Example 9 includes any preceding examples, wherein the recurring resource identifies a physical location.

Example 10 includes any preceding claim, wherein the request indicates a request for recurring meetings with the one or more users, wherein the cadence identifies a frequency of the meetings, wherein the range identifies a time margin that is based on the frequency of the meetings.

Example 11 includes example 10, wherein the period identifies a recurring time window, a duration of the time window being based on the time margin.

Example 12 includes any preceding examples, wherein the user resource data indicate available time slots in the calendar data of the one or more users.

Example 13 includes any preceding examples, wherein the request to allocate the recurring resource of the application to the one or more users comprises a request to allocate nodes or processor cores in a data center.

Example 14 includes a computer-readable storage medium, the computer-readable storage medium including instructions that when executed by a computer, cause the computer to perform operations implementing the method of any of example 1 to example 13.

Example 15 is a non-transitory computer-readable storage medium, the computer-readable storage medium including instructions that when executed by a computer, cause the computer to: receive, at a server, a request to allocate a recurring resource of an application to computing devices associated with one or more users; identify a cadence of the recurring resource and a range based on the cadence; identify a period based on the cadence and the range; access user resource data of the application for each period; iteratively compute a resource availability score for the period based on the corresponding user resource data; determine that the resource availability score of an instance of the period is less than a threshold value; and in response to determining that the resource availability score of the instance of the period is less than the threshold value, allocate, at the server, the recurring resource to instances of the period where the corresponding resource availability score exceeds the threshold value.

What is claimed is:

1. A computer-implemented method comprising:
receiving, at a server, a request to allocate a recurring resource of an application to computing devices associated with one or more users;
identifying a cadence of the recurring resource and a range based on the cadence;
identifying a period based on the cadence and the range;
accessing user resource data of the application for each period;
iteratively computing a resource availability score for the period based on the corresponding user resource data;
determining that the resource availability score of an instance of the period is less than a threshold value; and
in response to determining that the resource availability score of the instance of the period is less than the threshold value, allocating, at the server, the recurring resource to instances of the period where the corresponding resource availability score exceeds the threshold value.

2. The computer-implemented method of claim 1, comprising:
determining, for each period, a number of available time slots, in calendar data of the one or more users, that are available to accommodate the request; and
computing the resource availability score for each period based on the number of available time slots of the one or more users for each period.

3. The computer-implemented method of claim 1, comprising:
computing a first resource availability score for a first instance of the period based on the corresponding user resource data;
determining that the first resource availability score of the first instance of the period is greater than the threshold value; and
in response to determining that the first resource availability score of first instance of the period is greater than the threshold value, iteratively computing a second resource availability score for a second instance of the period based on the corresponding user resource data.

4. The computer-implemented method of claim 3, comprising:
determining that the second resource availability score of the second instance of the period is less than the threshold value; and
allocating, at the server, the recurring resource to the first instance of the period.

5. The computer-implemented method of claim 4, comprising:
determining that the second resource availability score of the second instance of the period is greater than the threshold value;
in response to determining that the second resource availability score of second instance of the period is greater than the threshold value, iteratively computing a third resource availability score for a third instance of the period based on the corresponding user resource data;
determining that the third resource availability score of the third instance of the period is less than the threshold value; and
allocating, at the server, the recurring resource to the first and second instance of the period.

6. The computer-implemented method of claim 5, comprising:
monitoring the resource availability score for each future period based on the corresponding user resource data; and
adjusting the threshold value based on the resource availability score for each future period.

7. The computer-implemented method of claim 1, comprising:
accessing a mapping table that maps the cadence with a time margin; and
determining the range based on the time margin from the mapping table.

8. The computer-implemented method of claim 1, wherein the recurring resource identifies a recurring available time slot in calendar data of the user resource data.

9. The computer-implemented method of claim 8, wherein the recurring resource identities a physical location.

10. The computer-implemented method of claim 1, wherein the request indicates a request for recurring meetings with the one or more users, wherein the cadence identifies a frequency of the meetings, wherein the range identifies a time margin that is based on the frequency of the meetings.

11. The computer-implemented method of claim 10, wherein the period identifies a recurring time window, a duration of the time window being based on the time margin.

12. The computer-implemented method of claim 1, wherein the user resource data indicate available time slots in the calendar data of the one or more users.

13. The computer-implemented method of claim 1, wherein the request to allocate the recurring resource of the application to the one or more users comprises a request to allocate nodes or processor cores in a data center.

14. A computer-readable storage medium, the computer-readable storage medium including instructions that when executed by a computer, cause the computer to
receive, at a server, a request to allocate a recurring resource of an application to computing devices associated with one or more users;
identify a cadence of the recurring resource and a range based on the cadence;
identify a period based on the cadence and the range;
access user resource data of the application for each period;
iteratively compute a resource availability score for the period based on the corresponding user resource data;
determine that the resource availability score of an instance of the period is less than a threshold value; and
in response to determining that the resource availability score of the instance of the period is less than the threshold value, allocate, at the server, the recurring resource to instances of the period where the corresponding resource availability score exceeds the threshold value.

15. A non-transitory completer-readable storage medium, the computer-readable storage medium including instructions that when executed by a computer, cause the computer to:
receive, at a server, a request to allocate a recurring resource of an application to computing devices associated with one or more users;
identify a cadence of the recurring resource and a range based on the cadence;
identify a period based on the cadence and the range;
access user resource data of the application for each period;
iteratively compute a resource availability score for the period based on the corresponding user resource data;
determine that the resource availability score of an instance of the period is less than a threshold value; and
in response to determining that the resource availability score of the instance of the period is less than the threshold value, allocate, at the server, the recurring resource to instances of the period where the corresponding resource availability score exceeds the threshold value.
